(19) United States
(12) Patent Application Publication
(10) Pub. No.: US 2024/0177000 A1
(43) Pub. Date: May 30, 2024

(54) System and Method for Training Machine-Learning Models with Probabilistic Confidence Labels

(71) Applicant: Carnegie Mellon University, Pittsburgh, PA (US)

(72) Inventors: John Michael Galeotti, Pittsburgh, PA (US); Gautam Rajendrakumar Gare, Pittsburgh, PA (US)

(21) Appl. No.: 18/283,922

(22) PCT Filed: Mar. 24, 2022
(86) PCT No.: PCT/US22/21634

§ 371 Date: Sep. 25, 2023

Related U.S. Application Data
(60) Provisional application No. 63/165,188, filed on Mar. 24, 2021.

(51) Int. Cl. G06N 3/08; G06N 3/048

(52) U.S. Cl. CPC G06N 3/08; G06N 3/048

(57) ABSTRACT

Provided is a system, method, and computer program product for training a machine-learning model. The method includes labeling each object of a plurality of objects with a probabilistic confidence label including a probability classification score for each class of at least two classes, resulting in a plurality of probabilistic confidence labels associated with the plurality of objects, and training, with at least one computing device, the machine-learning model based on the plurality of objects and the plurality of probabilistic confidence labels.

### CROSS REFERENCE TO RELATED APPLICATION

This application claims priority to U.S. Provisional Patent Application No. 63/165,188, filed Mar. 24, 2021, the disclosure of which is incorporated herein by reference in its entirety.

### GOVERNMENT LICENSE RIGHTS

This invention was made with Government support under W81XWH-19-C-0083 awarded by U.S. Army Medical Research Activity. The Government has certain rights in the invention.

### BACKGROUND

### 1. Field

This disclosure relates generally to machine-learning models and, in non-limiting embodiments, to systems, methods, and computer program products for training a machine-learning model, such as an artificial neural network, with probabilistic confidence labels.

### 2. Technical Considerations

Class labels used for machine learning are relatable to each other, with certain class labels being more similar to each other than others (e.g., images of cats and dogs are more similar to each other than those of cats and cars). Such similarity among classes is often the cause of poor model performance due to models confusing between them. Current labeling techniques fail to explicitly capture such similarity information.

Existing techniques for training an artificial neural network (ANN) for classification do not use supervision for inter-class similarity due to the labels of the data used in training not capturing such information.

### SUMMARY

According to non-limiting embodiments or aspects, provided is a method for training a machine-learning model, comprising: labeling each object of a plurality of objects with a probabilistic confidence label comprising a probability classification score for each class of at least two classes, resulting in a plurality of probabilistic confidence labels associated with the plurality of objects; and training, with at least one computing device, the machine-learning model based on the plurality of objects and the plurality of probabilistic confidence labels.

In non-limiting embodiments or aspects, wherein labeling each object of the plurality of objects comprises: receiving, from a plurality of labelers, a plurality of classification scores for each object of the plurality of objects; and determining a weighted probability classification score for each object of the plurality of objects based on the plurality of classification scores for the object. In non-limiting embodiments or aspects, the weighted probability classification score is based on weighing scores from each labeler of the plurality of labelers based on a corresponding confidence score of the labeler. In non-limiting embodiments or aspects, wherein labeling each object of the plurality of objects comprises: receiving, from a plurality of machine-learning models, outputs comprising a plurality of probability classification scores for each object of the plurality of objects; and combining the outputs. In non-limiting embodiments or aspects, the plurality of machine-learning models comprises a plurality of artificial neural networks (ANNs), and the outputs comprise outputs from each last layer of each ANN of the plurality of ANNs.

In non-limiting embodiments or aspects, the method further comprises applying a softmax activation layer to each output before or after combining the outputs. In non-limiting embodiments or aspects, the method further comprises: determining a weighted probability classification score for each object of the plurality of objects based on the plurality of probability classification scores for the object, the weighted probability classification score is based on weighing scores from each machine-learning model of the plurality of machine-learning models based on a corresponding accuracy of the machine-learning model. In non-limiting embodiments or aspects, wherein labeling each object of the plurality of objects comprises: receiving, from a plurality of labelers, a first plurality of probability classification scores for each object of the plurality of objects; and receiving, from a plurality of ANNs, outputs from each last layer of each ANN of the plurality of ANNs, the outputs comprising a second plurality of probability classification scores for each object of the plurality of objects. In non-limiting embodiments or aspects, wherein training the machine-learning model comprises: inputting at least one object of the plurality of objects to the machine-learning model; receiving, from the machine-learning model, an output vector; determining an inner product of the output vector and a vector based on the plurality of probabilistic confidence labels; and optimizing the machine-learning model based on a loss function calculated based on the inner product.

In non-limiting embodiments or aspects, the output vector comprises a plurality of elements representing a plurality of classes of the at least one object. In non-limiting embodiments or aspects, the plurality of objects comprises a plurality of medical images. In non-limiting embodiments or aspects, the plurality of objects comprises portions of a plurality of medical images. In non-limiting embodiments or aspects, wherein labeling each object of the plurality of objects comprises labeling a portion of a medical image of the plurality of medical images. In non-limiting embodiments or aspects, the method further comprises: normalizing, with at least one computing device, the plurality of probabilistic confidence labels before training the machine-learning model such that each probability classification score for each probabilistic confidence label sums to a constant value. In non-limiting embodiments or aspects, wherein normalizing the plurality of probabilistic confidence labels comprises: determining at least one value for at least one missing probability classification score of the plurality of probabilistic confidence labels.

In non-limiting embodiments or aspects, wherein determining the at least one value is based on at least one of the following: a nearest neighbor algorithm, a smoothing process, or any combination thereof. In non-limiting embodiments or aspects, wherein normalizing the plurality of probabilistic confidence labels comprises: adjusting a magnitude of at least one probability classification score of at least one probabilistic confidence label. In non-limiting embodiments or aspects, wherein training the machine-learning model comprises: optimizing the machine-learning model based on a projective loss function. In non-limiting embodiments or aspects, the method further comprises: relaxing a loss penalization of the projective loss function based on a plurality of target classifications. In non-limiting embodiments or aspects, wherein relaxing the loss penalization comprises: applying a first relaxation function for a plurality of noisy training data samples; and applying a second relaxation function for a plurality of trusted training data samples, the second relaxation function different than the first relaxation function. In non-limiting embodiments or aspects, wherein training the machine-learning model comprises: optimizing the machine-learning model based on a one-hot-encoding loss function, wherein one-hot labels are substituted with a relaxed confidence label.

According to non-limiting embodiments or aspects, provided is a system for training a machine-learning model, comprising at least one computing device programmed or configured to: label each object of a plurality of objects with a probabilistic confidence label comprising a probability classification score for each class of at least two classes, resulting in a plurality of probabilistic confidence labels associated with the plurality of objects; and train the machine-learning model based on the plurality of objects and the plurality of probabilistic confidence labels.

In non-limiting embodiments or aspects, wherein labeling each object of the plurality of objects comprises: receive, from a plurality of labelers, a plurality of classification scores for each object of the plurality of objects; and determine a weighted probability classification score for each object of the plurality of objects based on the plurality of classification scores for the object. In non-limiting embodiments or aspects, the weighted probability classification score is based on weighing scores from each labeler of the plurality of labelers based on a corresponding confidence score of the labeler. In non-limiting embodiments or aspects, wherein labeling each object of the plurality of objects comprises: receive, from a plurality of machine-learning models, outputs comprising a plurality of probability classification scores for each object of the plurality of objects; and combine the outputs. In non-limiting embodiments or aspects, the plurality of machine-learning models comprises a plurality of artificial neural networks (ANNs), and the outputs comprise outputs from each last layer of each ANN of the plurality of ANNs.

In non-limiting embodiments or aspects, the computing device is further programmed or configured to apply a softmax activation layer to each output before or after combining the outputs. In non-limiting embodiments or aspects, the computing device is further programmed or configured to: determine a weighted probability classification score for each object of the plurality of objects based on the plurality of probability classification scores for the object, the weighted probability classification score is based on weighing scores from each machine-learning model of the plurality of machine-learning models based on a corresponding accuracy of the machine-learning model. In non-limiting embodiments or aspects, wherein labeling each object of the plurality of objects comprises: receive, from a plurality of labelers, a first plurality of probability classification scores for each object of the plurality of objects; and receive, from a plurality of ANNs, outputs from each last layer of each ANN of the plurality of ANNs, the outputs comprising a second plurality of probability classification scores for each object of the plurality of objects. In non-limiting embodiments or aspects, wherein training the machine-learning model comprises: inputting at least one object of the plurality of objects to the machine-learning model; receiving, from the machine-learning model, an output vector; determining an inner product of the output vector and a vector based on the plurality of probabilistic confidence labels; and optimizing the machine-learning model based on a loss function calculated based on the inner product.

In non-limiting embodiments or aspects, the output vector comprises a plurality of elements representing a plurality of classes of the at least one object. In non-limiting embodiments or aspects, the plurality of objects comprises a plurality of medical images. In non-limiting embodiments or aspects, the plurality of objects comprises portions of a plurality of medical images. In non-limiting embodiments or aspects, wherein labeling each object of the plurality of objects comprises labeling a portion of a medical image of the plurality of medical images. In non-limiting embodiments or aspects, the computing device is further programmed or configured to: normalize the plurality of probabilistic confidence labels before training the machine-learning model such that each probability classification score for each probabilistic confidence label sums to a constant value. In non-limiting embodiments or aspects, wherein normalizing the plurality of probabilistic confidence labels comprises: determining at least one value for at least one missing probability classification score of the plurality of probabilistic confidence labels. In non-limiting embodiments or aspects, wherein determining the at least one value is based on at least one of the following: a nearest neighbor algorithm, a smoothing process, or any combination thereof.

In non-limiting embodiments or aspects, wherein normalizing the plurality of probabilistic confidence labels comprises: adjusting a magnitude of at least one probability classification score of at least one probabilistic confidence label. In non-limiting embodiments or aspects, wherein training the machine-learning model comprises: optimizing the machine-learning model based on a projective loss function. In non-limiting embodiments or aspects, the computing device is further programmed or configured to: relax a loss penalization of the projective loss function based on a plurality of target classifications. In non-limiting embodiments or aspects, wherein relaxing the loss penalization comprises: applying a first relaxation function for a plurality of noisy training data samples; and applying a second relaxation function for a plurality of trusted training data samples, the second relaxation function different than the first relaxation function. In non-limiting embodiments or aspects, wherein training the machine-learning model comprises: optimizing the machine-learning model based on a one-hot-encoding loss function, wherein one-hot labels are substituted with a relaxed confidence label.

According to non-limiting embodiments or aspects, provided is a computer program product for training a machine-learning model, comprising at least one non-transitory computer-readable medium including program instructions that, when executed by at least one computing device, cause the at least one computing device to: label each object of a plurality of objects with a probabilistic confidence label comprising a probability classification score for each class of at least two classes, resulting in a plurality of probabilistic confidence labels associated with the plurality of objects; and train the machine-learning model based on the plurality of objects and the plurality of probabilistic confidence labels.

In non-limiting embodiments or aspects, wherein labeling each object of the plurality of objects comprises: receiving, from a plurality of labelers, a plurality of classification scores for each object of the plurality of objects; and determine a weighted probability classification score for each object of the plurality of objects based on the plurality of classification scores for the object. In non-limiting embodiments or aspects, the weighted probability classification score is based on weighing scores from each labeler of the plurality of labelers based on a corresponding confidence score of the labeler. In non-limiting embodiments or aspects, wherein labeling each object of the plurality of objects comprises: receiving, from a plurality of machine-learning models, outputs comprising a plurality of probability classification scores for each object of the plurality of objects; and combine the outputs. In non-limiting embodiments or aspects, the plurality of machine-learning models comprises a plurality of artificial neural networks (ANNs), and the outputs comprise outputs from each last layer of each ANN of the plurality of ANNs.

In non-limiting embodiments or aspects, the computing device is further caused to apply a softmax activation layer to each output before or after combining the outputs. In non-limiting embodiments or aspects, the computing device is further caused to: determine a weighted probability classification score for each object of the plurality of objects based on the plurality of probability classification scores for the object, the weighted probability classification score is based on weighing scores from each machine-learning model of the plurality of machine-learning models based on a corresponding accuracy of the machine-learning model. In non-limiting embodiments or aspects, wherein labeling each object of the plurality of objects comprises: receiving, from a plurality of labelers, a first plurality of probability classification scores for each object of the plurality of objects; and receiving, from a plurality of ANNs, outputs from each last layer of each ANN of the plurality of ANNs, the outputs comprising a second plurality of probability classification scores for each object of the plurality of objects. In non-limiting embodiments or aspects, wherein training the machine-learning model comprises: inputting at least one object of the plurality of objects to the machine-learning model; receiving, from the machine-learning model, an output vector; determining an inner product of the output vector and a vector based on the plurality of probabilistic confidence labels; and optimizing the machine-learning model based on a loss function calculated based on the inner product.

In non-limiting embodiments or aspects, the output vector comprises a plurality of elements representing a plurality of classes of the at least one object. In non-limiting embodiments or aspects, the plurality of objects comprises a plurality of medical images. In non-limiting embodiments or aspects, the plurality of objects comprises portions of a plurality of medical images. In non-limiting embodiments or aspects, wherein labeling each object of the plurality of objects comprises labeling a portion of a medical image of the plurality of medical images. In non-limiting embodiments or aspects, the computing device is further caused to: normalize the plurality of probabilistic confidence labels before training the machine-learning model such that each probability classification score for each probabilistic confidence label sums to a constant value. In non-limiting embodiments or aspects, wherein normalizing the plurality of probabilistic confidence labels comprises: determining at least one value for at least one missing probability classification score of the plurality of probabilistic confidence labels. In non-limiting embodiments or aspects, wherein determining the at least one value is based on at least one of the following: a nearest neighbor algorithm, a smoothing process, or any combination thereof. In non-limiting embodiments or aspects, wherein normalizing the plurality of probabilistic confidence labels comprises: adjusting a magnitude of at least one probability classification score of at least one probabilistic confidence label.

In non-limiting embodiments or aspects, wherein training the machine-learning model comprises: optimizing the machine-learning model based on a projective loss function. In non-limiting embodiments or aspects, the computing device is further caused to: relax a loss penalization of the projective loss function based on a plurality of target classifications. In non-limiting embodiments or aspects, wherein relaxing the loss penalization comprises: applying a first relaxation function for a plurality of noisy training data samples; and applying a second relaxation function for a plurality of trusted training data samples, the second relaxation function different than the first relaxation function. In non-limiting embodiments or aspects, wherein training the machine-learning model comprises: optimizing the machine-learning model based on a one-hot-encoding loss function, wherein one-hot labels are substituted with a relaxed confidence label.

Further non-limiting embodiments are set forth in the following clauses:

Clause 1: A method for training a machine-learning model, comprising: labeling each object of a plurality of objects with a probabilistic confidence label comprising a probability classification score for each class of at least two classes, resulting in a plurality of probabilistic confidence labels associated with the plurality of objects; and training, with at least one computing device, the machine-learning model based on the plurality of objects and the plurality of probabilistic confidence labels.

Clause 2: The method of clause 1, wherein labeling each object of the plurality of objects comprises: receiving, from a plurality of labelers, a plurality of classification scores for each object of the plurality of objects; and determining a weighted probability classification score for each object of the plurality of objects based on the plurality of classification scores for the object.

Clause 3: The method of clauses 1 or 2, wherein the weighted probability classification score is based on weighing scores from each labeler of the plurality of labelers based on a corresponding confidence score of the labeler.

Clause 4: The method of any of clauses 1-3, wherein labeling each object of the plurality of objects comprises: receiving, from a plurality of machine-learning models, outputs comprising a plurality of probability classification scores for each object of the plurality of objects; and combining the outputs.

Clause 5: The method of any of clauses 1-4, wherein the plurality of machine-learning models comprises a plurality of artificial neural networks (ANNs), and wherein the outputs comprise outputs from each last layer of each ANN of the plurality of ANNs.

Clause 6: The method of any of clauses 1-5, further comprising applying a softmax activation layer to each output before or after combining the outputs.

Clause 7: The method of any of clauses 1-6, further comprising: determining a weighted probability classification score for each object of the plurality of objects based on the plurality of probability classification scores for the object, wherein the weighted probability classification score is based on weighing scores from each machine-learning model of the plurality of machine-learning models based on a corresponding accuracy of the machine-learning model.

Clause 8: The method of any of clauses 1-7, wherein labeling each object of the plurality of objects comprises: receiving, from a plurality of labelers, a first plurality of probability classification scores for each object of the plurality of objects; and receiving, from a plurality of ANNs, outputs from each last layer of each ANN of the plurality of ANNs, the outputs comprising a second plurality of probability classification scores for each object of the plurality of objects.

Clause 9: The method of any of clauses 1-8, wherein training the machine-learning model comprises: inputting at least one object of the plurality of objects to the machine-learning model; receiving, from the machine-learning model, an output vector; determining an inner product of the output vector and a vector based on the plurality of probabilistic confidence labels; and optimizing the machine-learning model based on a loss function calculated based on the inner product.

Clause 10: The method of any of clauses 1-9, wherein the output vector comprises a plurality of elements representing a plurality of classes of the at least one object.

Clause 11: The method of any of clauses 1-10, wherein the plurality of objects comprises a plurality of medical images.

Clause 12: The method of any of clauses 1-11, wherein the plurality of objects comprises portions of a plurality of medical images.

Clause 13: The method of any of clauses 1-12, wherein labeling each object of the plurality of objects comprises labeling a portion of a medical image of the plurality of medical images.

Clause 14: The method of any of clauses 1-13, further comprising: normalizing, with at least one computing device, the plurality of probabilistic confidence labels before training the machine-learning model such that each probability classification score for each probabilistic confidence label sums to a constant value.

Clause 15: The method of any of clauses 1-14, wherein normalizing the plurality of probabilistic confidence labels comprises: determining at least one value for at least one missing probability classification score of the plurality of probabilistic confidence labels.

Clause 16: The method of any of clauses 1-15, wherein determining the at least one value is based on at least one of the following: a nearest neighbor algorithm, a smoothing process, or any combination thereof.

Clause 17: The method of any of clauses 1-16, wherein normalizing the plurality of probabilistic confidence labels comprises: adjusting a magnitude of at least one probability classification score of at least one probabilistic confidence label.

Clause 18: The method of any of clauses 1-17, wherein training the machine-learning model comprises: optimizing the machine-learning model based on a projective loss function.

Clause 19: The method of any of clauses 1-18, further comprising: relaxing a loss penalization of the projective loss function based on a plurality of target classifications.

Clause 20: The method of any of clauses 1-19, wherein relaxing the loss penalization comprises: applying a first relaxation function for a plurality of noisy training data samples; and applying a second relaxation function for a plurality of trusted training data samples, the second relaxation function different than the first relaxation function.

Clause 21: The method of any of clauses 1-20, wherein training the machine-learning model comprises: optimizing the machine-learning model based on a one-hot-encoding loss function, wherein one-hot labels are substituted with a relaxed confidence label.

Clause 22: A system for training a machine-learning model, comprising at least one computing device programmed or configured to: label each object of a plurality of objects with a probabilistic confidence label comprising a probability classification score for each class of at least two classes, resulting in a plurality of probabilistic confidence labels associated with the plurality of objects; and train the machine-learning model based on the plurality of objects and the plurality of probabilistic confidence labels.

Clause 23: The system of clause 22, wherein labeling each object of the plurality of objects comprises: receive, from a plurality of labelers, a plurality of classification scores for each object of the plurality of objects; and determine a weighted probability classification score for each object of the plurality of objects based on the plurality of classification scores for the object.

Clause 24: The system of clauses 22 or 23, wherein the weighted probability classification score is based on weighing scores from each labeler of the plurality of labelers based on a corresponding confidence score of the labeler.

Clause 25: The system of any of clauses 22-24, wherein labeling each object of the plurality of objects comprises: receive, from a plurality of machine-learning models, outputs comprising a plurality of probability classification scores for each object of the plurality of objects; and combine the outputs.

Clause 26: The system of any of clauses 22-25, wherein the plurality of machine-learning models comprises a plurality of artificial neural networks (ANNs), and wherein the outputs comprise outputs from each last layer of each ANN of the plurality of ANNs.

Clause 27: The system of any of clauses 22-26, the computing device further programmed or configured to apply a softmax activation layer to each output before or after combining the outputs.

Clause 26: The system of any of clauses 22-25, wherein the plurality of machine-learning models comprises a plurality of artificial neural networks (ANNs), and wherein the outputs comprise outputs from each last layer of each ANN of the plurality of ANNs.

Clause 27: The system of any of clauses 22-26, wherein the computing device is further programmed or configured to apply a softmax activation layer to each output before or after combining the outputs.

Clause 28: The system of any of clauses 22-27, wherein the computing device is further programmed or configured to: determine a weighted probability classification score for each object of the plurality of objects based on the plurality of probability classification scores for the object, and wherein the weighted probability classification score is based on weighing scores from each machine-learning model of the plurality of machine-learning models based on a corresponding accuracy of the machine-learning model.

Clause 29: The system of any of clauses 22-28, wherein labeling each object of the plurality of objects comprises: receiving, from a plurality of labelers, a first plurality of probability classification scores for each object of the plurality of objects; and receiving, from a plurality of ANNs, outputs from each last layer of each ANN of the plurality of ANNs, the outputs comprising a second plurality of probability classification scores for each object of the plurality of objects.

Clause 30: The system of any of clauses 22-29, wherein training the machine-learning model comprises: inputting at least one object of the plurality of objects to the machine-learning model; receiving, from the machine-learning model, an output vector; determining an inner product of the output vector and a vector based on the plurality of probabilistic confidence labels; and optimizing the machine-learning model based on a loss function calculated based on the inner product.

Clause 31: The system of any of clauses 22-30, wherein the output vector comprises a plurality of elements representing a plurality of classes of the at least one object.

Clause 32: The system of any of clauses 22-31, wherein the plurality of objects comprises a plurality of medical images.

Clause 33: The system of any of clauses 22-32, wherein the plurality of objects comprises portions of a plurality of medical images.

Clause 34: The system of any of clauses 22-33, wherein labeling each object of the plurality of objects comprises labeling a portion of a medical image of the plurality of medical images.

Clause 35: The system of any of clauses 22-34, wherein the computing device is further programmed or configured to: normalize the plurality of probabilistic confidence labels before training the machine-learning model such that each probability classification score for each probabilistic confidence label sums to a constant value.

Clause 36: The system of any of clauses 22-35, wherein normalizing the plurality of probabilistic confidence labels comprises: determining at least one value for at least one missing probability classification score of the plurality of probabilistic confidence labels.

Clause 37: The system of any of clauses 22-36, wherein determining the at least one value is based on at least one of the following: a nearest neighbor algorithm, a smoothing process, or any combination thereof.

Clause 38: The system of any of clauses 22-37, wherein normalizing the plurality of probabilistic confidence labels comprises: adjusting a magnitude of at least one probability classification score of at least one probabilistic confidence label.

Clause 39: The system of any of clauses 22-38, wherein training the machine-learning model comprises: optimizing the machine-learning model based on a projective loss function.

Clause 40: The system of any of clauses 22-39, wherein the computing device is further programmed or configured to: relax a loss penalization of the projective loss function based on a plurality of target classifications.

Clause 41: The system of any of clauses 22-40, wherein relaxing the loss penalization comprises: applying a first relaxation function for a plurality of noisy training data samples; and applying a second relaxation function for a plurality of trusted training data samples, the second relaxation function different than the first relaxation function.

Clause 42: The system of any of clauses 22-41, wherein training the machine-learning model comprises: optimizing the machine-learning model based on a one-hot-encoding loss function, wherein one-hot labels are substituted with a relaxed confidence label.

Clause 43: A computer program product for training a machine-learning model, comprising at least one non-transitory computer-readable medium including program instructions that, when executed by at least one computing device, cause the at least one computing device to: label each object of a plurality of objects with a probabilistic confidence label comprising a probability classification score for each class of at least two classes, resulting in a plurality of probabilistic confidence labels associated with the plurality of objects; and train the machine-learning model based on the plurality of objects and the plurality of probabilistic confidence labels.

Clause 44: The computer program product of clause 43, wherein labeling each object of the plurality of objects comprises: receiving, from a plurality of labelers, a plurality of classification scores for each object of the plurality of objects; and determining a weighted probability classification score for each object of the plurality of objects based on the plurality of classification scores for the object.

Clause 45: The computer program product of clauses 43 or 44, wherein the weighted probability classification score is based on weighing scores from each labeler of the plurality of labelers based on a corresponding confidence score of the labeler.

Clause 46: The computer program product of any of clauses 43-45, wherein labeling each object of the plurality of objects comprises: receive, from a plurality of machine-learning models, outputs comprising a plurality of probability classification scores for each object of the plurality of objects; and combine the outputs.

Clause 47: The computer program product of any of clauses 43-46, wherein the plurality of machine-learning models comprises a plurality of artificial neural networks (ANNs), and wherein the outputs comprise outputs from each last layer of each ANN of the plurality of ANNs.

Clause 48: The computer program product of any of clauses 43-47, wherein the computing device is further caused to apply a softmax activation layer to each output before or after combining the outputs.

Clause 49: The computer program product of any of clauses 43-48, wherein the computing device is further caused to: determine a weighted probability classification score for each object of the plurality of objects based on the plurality of probability classification scores for the object, and wherein the weighted probability classification score is based on weighing scores from each machine-learning model of the plurality of machine-learning models based on a corresponding accuracy of the machine-learning model.

Clause 50: The computer program product of any of clauses 43-49, wherein labeling each object of the plurality of objects comprises: receive, from a plurality of labelers, a first plurality of probability classification scores for each object of the plurality of objects; and receive, from a plurality of ANNs, outputs from each last layer of each ANN of the plurality of ANNs, the outputs comprising a second plurality of probability classification scores for each object of the plurality of objects.

Clause 51: The computer program product of any of clauses 43-50, wherein training the machine-learning model comprises: inputting at least one object of the plurality of objects to the machine-learning model; receiving, from the machine-learning model, an output vector; determining an inner product of the output vector and a vector based on the plurality of probabilistic confidence labels; and optimizing the machine-learning model based on a loss function calculated based on the inner product.

Clause 52: The computer program product of any of clauses 43-51, wherein the output vector comprises a plurality of elements representing a plurality of classes of the at least one object.

Clause 53: The computer program product of any of clauses 43-52, wherein the plurality of objects comprises a plurality of medical images.

Clause 54: The computer program product of any of clauses 43-53, wherein the plurality of objects comprises portions of a plurality of medical images.

Clause 55: The computer program product of any of clauses 43-54, wherein labeling each object of the plurality of objects comprises labeling a portion of a medical image of the plurality of medical images.

Clause 56: The computer program product of any of clauses 43-55, wherein the computing device is further caused to: normalize the plurality of probabilistic confidence labels before training the machine-learning model such that each probability classification score for each probabilistic confidence label sums to a constant value.

Clause 57: The computer program product of any of clauses 43-56, wherein normalizing the plurality of probabilistic confidence labels comprises: determining at least one value for at least one missing probability classification score of the plurality of probabilistic confidence labels.

Clause 58: The computer program product of any of clauses 43-57, wherein determining the at least one value is based on at least one of the following: a nearest neighbor algorithm, a smoothing process, or any combination thereof.

Clause 59: The computer program product of any of clauses 43-58, wherein normalizing the plurality of probabilistic confidence labels comprises: adjusting a magnitude of at least one probability classification score of at least one probabilistic confidence label.

Clause 60: The computer program product of any of clauses 43-59, wherein training the machine-learning model comprises: optimizing the machine-learning model based on a projective loss function.

Clause 61: The computer program product of any of clauses 43-60, wherein the computing device is further caused to: relax a loss penalization of the projective loss function based on a plurality of target classifications.

Clause 62: The computer program product of any of clauses 43-61, wherein relaxing the loss penalization comprises: applying a first relaxation function for a plurality of noisy training data samples; and applying a second relaxation function for a plurality of trusted training data samples, the second relaxation function different than the first relaxation function.

Clause 63: The computer program product of any of clauses 43-62, wherein training the machine-learning model comprises: optimizing the machine-learning model based on a one-hot-encoding loss function, wherein one-hot labels are substituted with a relaxed confidence label.

These and other features and characteristics of the present disclosure, as well as the methods of operation and functions of the related elements of structures and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the invention.

### BRIEF DESCRIPTION OF THE DRAWINGS

Additional advantages and details are explained in greater detail below with reference to the non-limiting, exemplary embodiments that are illustrated in the accompanying drawings, in which:

FIG. 1 illustrates a system for training a machine-learning model with probabilistic confidence labels according to non-limiting embodiments;

FIG. 2 illustrates example components of a computing device used in connection with non-limiting embodiments;

FIG. 3 illustrates a flow diagram for a method of training a machine-learning model with probabilistic confidence labels according to non-limiting embodiments; and

FIG. 4 illustrates a visualization of the projection loss function's relaxation region and target confidence label according to non-limiting embodiments.

### DETAILED DESCRIPTION

It is to be understood that the embodiments may assume various alternative variations and step sequences, except where expressly specified to the contrary. It is also to be understood that the specific devices and processes described in the following specification are simply exemplary embodiments or aspects of the disclosure. Hence, specific dimensions and other physical characteristics related to the embodiments or aspects disclosed herein are not to be considered as limiting. No aspect, component, element, structure, act, step, function, instruction, and/or the like used herein should be construed as critical or essential unless explicitly described as such. Also, as used herein, the articles “a” and “an” are intended to include one or more items and may be used interchangeably with “one or more” and “at least one.” Also, as used herein, the terms “has,” “have,” “having,” or the like are intended to be open-ended terms. Further, the phrase “based on” is intended to mean “based at least partially on” unless explicitly stated otherwise.

As used herein, the term “computing device” may refer to one or more electronic devices configured to process data. A computing device may, in some examples, include the necessary components to receive, process, and output data, such as a processor, a display, a memory, an input device, a network interface, and/or the like. A computing device may be a mobile device. A computing device may also be a desktop computer or other form of non-mobile computer. In non-limiting embodiments, a computing device may include an artificial intelligence (AI) accelerator, including an application-specific integrated circuit (ASIC) neural engine such as Apple's M1@ “Neural Engine” or Google's TENSORFLOW® processing unit. In non-limiting embodiments, a computing device may be comprised of a plurality of individual circuits.

In non-limiting embodiments, unique probabilistic confidence labels are provided to capture and exploit the similarities between classes and use such similarities to train a machine-learning model, such as an artificial neural network (ANN). For example, a cat bears more resemblance to a dog than to a car. Such distinctions that come easily to humans help us understand even unseen objects, but such similarities can also be the cause of confusion for current machine-learning and artificial intelligence systems due to class similarities. While existing approaches to labeling objects in images fail to capture such similarity information, non-limiting embodiments described herein improve upon ANNs and machine-learning models by training with projective loss functions that are able to relax the loss penalty in the model for errors that confuse similar classes. This improved training technique and loss function provides increased model performance as compared to training a model with a standard loss function.

Existing techniques for training a machine-learning model for classification do not use supervision for inter-class similarity due to the labels of the data used in training not capturing such information. The projective loss function is uniquely designed to work with probabilistic confidence labels with an ability to relax the loss penalty for errors that confuse similar classes. This can be used to train machine-learning models with noisy labels, as noisy labels are partly a result of confusability arising from class similarity. Probabilistic confidence labels introduce a-priori inter-class similarity information into training a machine-learning model, which, when coupled with the projective loss functions described herein, encourages both preserving and learning the naturally occurring class distributions. The training methods described herein have improved performance over the use of standard loss functions.

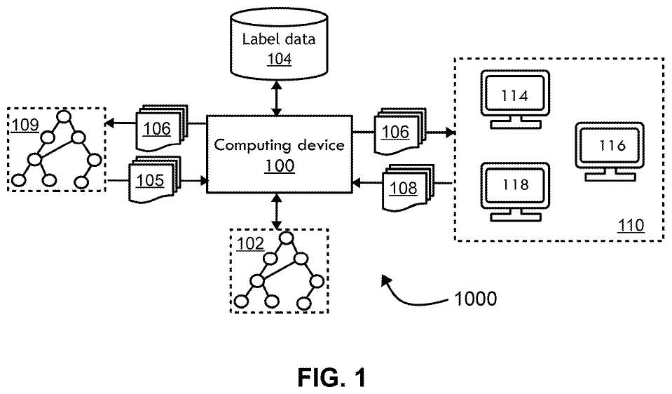

FIG. 1 shows a system 1000 for training an artificial neural network 102 according to non-limiting embodiments. The system includes a computing device 100 that includes and/or is in communication with a machine-learning model 102 configured to classify images and portions thereof. The computing device 100 communicates objects 106 (e.g., images or portions of images to be classified) to a group 110 of computing devices 114, 116, 118 associated with a plurality of labelers. The labelers may individually classify each object with a probabilistic confidence label 108 that is communicated back to the computing device 100 and stored in a label database 104. In non-limiting embodiments, the computing device 100 also communicates objects 106 to one or more machine-learning models 109 configured to generate probabilistic labels 105 for each object 106 and communicate the labels 105 to the computing device for storage in the label database 104. The computing device 100 uses the probabilistic labels 105, 108 to train the machine-learning model 102.

Each object may be labeled with a probabilistic confidence label that includes two or more classifications associated with a value. For example, an object may be labeled as a class “cat” at a 70% probability value, and as a class “dog” at a 20% probability value. Probabilistic confidence labels 108 can apply to an entire image (e.g., 70% likely dog, 25% wolf, 5% hyena) and/or to individual pixels. For example, an ambiguous-appearing pixel might be labeled by a human labeler (e.g., by computing device 114) as being 45% likely to be muscle, 25% muscle fascia, 15% fat, 10% fat fascia. As another example, if dogs and wolves are easily confused with each other, but not easily confused with cows, a human labeling a wolf can assign partial probability to the dog class but minimal (or zero) probability to the cow class. In this way, the machine-learning model 102 being trained can infer directly from the probabilistic confidence labels that wolves and dogs are similar, rather than having to learn this on its own (or not learn this similarity and later perform poorly when evaluating unusual new data).

With continued reference to FIG. 1, the computing device 100 may receive individual confidence scores from the group 110 and/or machine-learning model 109 and the computing device may generate the probabilistic confidence labels 105, 108 based on the received scores. The probabilistic confidence labels 105, 108 represent a likelihood of similarity (or confusability) between classes. In non-limiting embodiments, the probabilistic confidence labels 105, 108 may be each be represented by a vector of real or pseudo probabilities of each possible class. Probabilistic confidence labels may be obtained on a per-class basis, either through heuristic measures or by using pre-trained models.

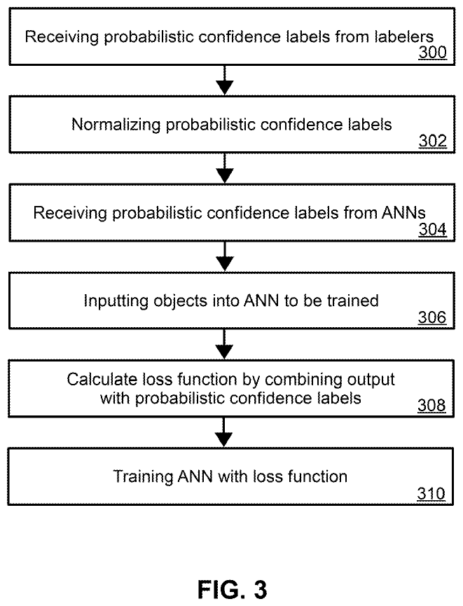

Referring now to FIG. 3, a flow diagram is shown for a method of training an artificial neural network according to non-limiting embodiments. The steps shown in FIG. 3 are for example purposes only. It will be appreciated that additional, fewer, different, and/or a different order of steps may be used in non-limiting embodiments. At step 300 probabilistic confidence labels are received from a plurality of labelers. In non-limiting embodiments, the confidence labels can be created using human labelers and/or with the use of other machine-learning model outputs. The examples shown in FIG. 1 show probabilistic confidence labels from both human (e.g., group 110) labelers and machine-learning models (e.g., machine-learning model 107), although it will be appreciated that only one source of labels is used in some non-limiting embodiments.

In the case of human labelers directly assigning confidence values to their individual labels, the human labelers are asked to assign the probability by which it appears to them that the object may belong to a particular class. The final probabilistic confidence label can be obtained as a computed combination of labels from multiple human labelers, such as a weighted score where the weight is proportional to the confidence/capability of the human labelers' accuracy/correctness. More complex algorithms may also be used to post-process and/or combine human labels (e.g., to detect and/or compensate for expected human behavior among labelers), including in part as described herein with respect to step 302 of FIG. 3.

After receiving probabilistic confidence labels from human labelers and/or from a combination of probabilistic confidence labels, the probabilistic confidence labels may be normalized at step 302. The human labelers may or may not have attempted to assign accurate probabilities, regardless of whether or not they were instructed to do so. In some circumstances human labelers may have simply indicated the most likely set of possible labels, possibly with some attempt at correct ranking (e.g., if a careful labeler might assign an image as 45% dog, 40% wolf, 10% hyena, 5% cat, then a less careful labeler might assign 45% dog, 45% wolf, 10% hyena, 0% cat or possibly 50% dog, 50% wolf, 0% hyena, 0% cat). Humans assigning per-pixel confidence labels might do so using tools like the paint brushes in graphical drawing programs, where the paint brushes may be configured to paint with decreasing brightness or opacity towards the edges of the brush (e.g., gradients), allowing for quick but approximate application of overlapping labels. For example, if red indicates muscle and yellow indicates fat, the shade of orange therefore indicates the approximate uncertainty between the two labels, and a human labeler might use a large-radius “feathered” digital brush to paint bright red over the pixels that are clearly muscle and bright yellow over pixels that are clearly fat, allowing the feathered edges of the brush to paint some amount of red and/or yellow on the less certain pixels at the edges of where the labeler is painting, without careful regard for the actual ratios of red and yellow on the uncertain pixels.

The use of human labelers can also lead to missing confidence labels, in which case the probabilistic confidence labels are processed such that the sum of the probability of an object across all possible classes equals one. Such missing values can be filled by various techniques such as a nearest neighbor algorithm and/or the like. For example, human labelers may assign fuzzy labels, wherein they assign free-form per-class scores (e.g., 1.0 dog, 0.2 wolf, 0.01 hyena) and post processing is required to create probabilistic representations, and may include applying smoothing, modeling, and/or the like, to achieve a desired format and/or properties. In non-limiting embodiments using images with semantic labels (e.g., pixel-based classification), various smoothening techniques can be applied (e.g., such as Bilateral filtering) to correct the errors in the probabilistic confidence labels. Once all of the labelers' annotations have been processed and combined, the result for each labeled image (or for each labeled pixel) may be determined to be the “gold standard” vector of probability-per-class values. The vector has the same number of dimensions as the number of classes.

At step 304, probabilistic confidence labels may be received from one or more machine-learning models configured to classify the objects. The outputs from the machine-learning models may not need normalization, although in some non-limiting embodiments they may be normalized as described herein with respect to step 302. In machine-learning model-based confidence labeling, the confidence label can be constructed as a weighted score of outputs from one or more machine-learning models, for example combining the last layers' output either before or after each last layer is passed through a softmax activation layer, to get the probability that an object belongs to a class. The weighting assigned to a machine-learning model may be proportional to the overall accuracy and numerical range of the model's prediction so as to ensure probabilities sum to one. In non-limiting embodiments, other smoothing, modeling, and/or the like techniques are used to achieve a desired format and/or properties. Similar to step 302, once all of the machine-learning models' outputs have been processed and combined, the result for each labeled image (or for each labeled pixel) may be determined to be the “gold standard” vector of probability-per-class values. The vector has the same number of dimensions as the number of classes. In the case where both human labelers and machine-learning models are used to generate the probabilistic confidence labels, they may be combined in an additional step (not shown in FIG. 3).

Probabilistic confidence labels can be approximately derived from traditionally labeled data. For example, in a case where a set of labeled images is a one-hot labeled data set (e.g., where each class is represented by a binary value in a vector of mutually exclusive per-class labels), there may be C label classifications, and two classes (a, b) may be considered (a, b c C), and a similarity score S can be based on a heuristic Has:

S_{ab}=H(a,b)

The similarity group Ga for class a may be defined as the classes having a similarity score S greater than a threshold r:

Gₐ=[b∈C if S_{ab}>τ]

The confidence score Cₐ(b) of a for class b is defined as:

$$\\ {C}_{a} [ b ] = \{ \begin{matrix}softmax ( {S}_{ab ) ,} & if b ∈ {G}_{a} \\ 0 , & otherwise\end{matrix}$$

where the softmax activation function may be applied to the similarity group Gₐ.

The confidence label T of class a is the collection of confidence scores Cₐ. In non-limiting embodiments, the similarity groups, scores, and/or heuristics may be defined manually (e.g. dogs and wolves may be manually assigned to a two-class similarity group, possibly by setting H(dogs, wolves)=τ+ε, H(wolves, dogs)=τ+ε, H(dogs, all classes except wolves)=0, and H(wolves, all classes except dogs)=0). Another option is to algorithmically define the similarity scores based on the outputs of pre-trained models or the like.

As an example, a dataset may include ten (10) class labels with certain class labels having a higher similarity than others. In non-limiting embodiments, similarity scores may be defined for the class labels following the same class-similarity groups (e.g., Gₐ), which may include, for example, classes A, B, C, D, E, F, H, I, J, K. In experiments, the confidence score Cₐ(A)=0.6 for the correct class A and Cₐ(B)=0.4 for the similar class B, as an example.

The spread of the confidence score may be restricted to a small group of similar classes, as confusion-inducing class similarity may often exist between a small subset of classes k. Accordingly, confidence labels are generally k sparse labels, but they can be thought of as a generic label definition. When k=1 they become normal one-hot labels, wherein the class under consideration is dissimilar from every other class. These labels may be referred to as hard confidence labels.

At step 306, the objects that were labeled by human labelers and/or machine-learning models and used to produce probabilistic confidence labels are input into the machine-learning model that is to be trained. The machine-learning model is configured to classify each object and to output probabilities of classifications. The scaled vector generated from the probabilistic confidence labels (e.g., the “gold standard” vector) and the vector output by the machine-learning model to be trained may be combined to generate a metric (e.g., value) from a loss function at step 308. The loss function may be configured to take advantage of the probabilistic confidence labels to assign more or less significance to individually labeled training images during the training. For example, the loss function may provide more training emphasis to the most trusted probabilistic confidence labels and less training emphasis on the least trusted probabilistic confidence labels. In other non-limiting embodiments, the loss function may be configured to take advantage of the probabilistic confidence labels to assign more or less significance to different kinds of errors by the artificial intelligence (AI) of the model during the training. For example, if an object in the training set were labeled as most likely being a dog (60%) but also possibly a wolf (40%), then the loss function might output little or no penalty if the AI predicted wolf for that object, whereas if another object were labeled as having a very high likelihood of being a dog (80%) then the loss function might output a higher penalty if the AI predicted wolf for that other object.

At step 308, the inner product of the two vectors may be calculated as an output of the loss function. Before taking the inner product, the vectors may be normalized (e.g., to unit length) or else the “gold-standard” vector may have its magnitude adjusted by a scaling factor (e.g., a temperature parameter, which may be in the range [0, 1.0] or may be allowed to exceed 1.0) that denotes the trust in the “gold-standard” vector. A lower temperature value indicates less trust in the ground truth confidence label, in which case the loss function is designed so that the machine-learning model gets more flexibility (e.g., less penalty) to disagree with the gold-standard predictions. This is because the magnitude of the machine-learning model output vector will have a higher magnitude relative to the scaled “gold standard” vector, leading to a larger inner product that results in a lower penalty. In non-limiting embodiments, a nonlinear scaling term, such as log, may also be introduced after the inner product in the loss function.

At step 310, the machine-learning model is trained. For example, the machine-learning model may be trained by inputting, into a training process, the input images (e.g., from step 306) and he loss function, such that the training process includes an iterative training loop in which the output of the model is repeatedly computed and evaluated with the loss function. The output of the loss function (e.g., from step 308) is then used to update the model. It is to be understood that training of machine-learning models typically entails repeatedly evaluating the output of the machine-learning model with the loss function, as the model is repeatedly adjusted by some training process. Other training paradigms are also possible, including pre-computing the loss function's values for all possible (or all relevant possible) outputs of the AI model.

In non-limiting embodiments, projective loss functions may be tailored for probabilistic confidence labels by reinforcing the naturally-occurring class similarity with the ability to relax the loss penalty for similar classes. The projective loss function is based on the inner product (e.g., dot product) that seeks to maximize the model prediction P(φ) projection onto the confidence label T, where φ represents the model parameters to be optimized. In non-limiting embodiments, a relaxation function r(t) may be applied to scale the target labels to relax the loss penalization for class labels that are less confident, thereby providing the model with the added flexibility to generate predictions that deviate from the labeled “truth,” which can be advantageous when processing noisy labels for which the actual truth is unknown.

In non-limiting embodiments, the projection (P) loss may represented as:

$$\\ {L}_{P} = max ( 0 , 〈 {T}_{r} , {T}_{r} 〉 - 〈 {T}_{r} , P ( ϕ ) 〉 )$$

$$\\ \frac{{dL}_{P}}{d ϕ} = - < {T}_{r} , \frac{dP ( ϕ )}{d ϕ} >$$

The log projection loss may be represented as:

$$\\ {L}_{LP} = max ( 0 , log ( \frac{〈 {T}_{r} , {T}_{r} 〉}{〈 {T}_{r} , P ( ϕ ) 〉} ) )$$

$$\\ \frac{{dL}_{LP}}{d ϕ} = - \frac{1}{〈 {T}_{r} , P ( ϕ ) 〉} 〈 {T}_{r} , \frac{dP ( ϕ )}{d ϕ} 〉 where , {T}_{r} = r {}_{} ( T )$$

In non-limiting embodiments, to ensure numerical stability a small constant (1e−08) is added to the loss.

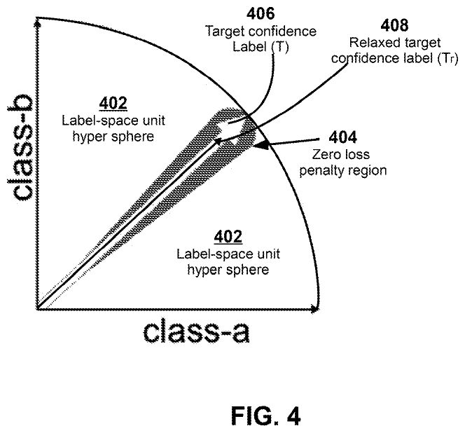

Referring now to FIG. 4, shown is a visualization of the projection loss function's relaxation region (e.g., a zero loss penalty region 404) around a relaxed target confidence label Tᵣ 408. This gives the model added flexibility to classify objects as either more like class-A or more like class-B, without incurring any loss penalty. The visualization shows the two-dimensional subspace of classes A and B within the multi-dimensional space of all possible classes, within which the target confidence label T 406 is in the region 404 with respect to the label-space (e.g., label-space unit hyper sphere 402).

In non-limiting embodiments, two relaxation functions may be used. The first relaxation function is an L2-norm function for training sample images that may be inaccurately labeled:

r_{noisy}(t)=∥t∥₂t

The second relaxation function may be a no-relaxation for a non-noisy trusted (sub)set of training sample images:

r_{trusted}(t)=t

The relaxation function r(t) lets the loss of closely-aligned training samples go to zero, allowing only the gradients of the samples that are clearly misclassified to pass. This can be related to the way focal loss and symmetric cross-entropy loss down-weight/regularize the gradients of the correctly classified samples. The relaxation function can result in a case where the loss goes to zero and no further learning can occur. In non-limiting embodiments, this could be addressed by modifying the relaxation function by introducing a scaling parameter.

In non-limiting embodiments, the projective loss function reinforces that classes of the same similarity group remain close in latent feature space while separating dissimilar classes. This differs from typical loss functions like cross-entropy loss, which impartially forces all class clusters to move apart (ideally to be orthogonal) without regard to inter-class similarity. Using the L2-norm, less-certain target confidence labels (with lower maximum confidence scores) are shrunk substantially and, subsequently, the model is only minimally penalized if swaying away from that training data's uncertain target confidence label. Similarly, confidence labels with higher confidence scores are shrunk by a small factor and, subsequently, the model is heavily penalized if swaying away from that training data's confident target label. The projection loss can be related to Cosine-Embedding Loss, but unlike cosine embedding which tries to bring closer the embeddings of samples belonging to a class and pull apart the embedding of different classes, projection loss works on the label space, where it tries to closely align the model prediction class to more-confident (or typical one-hot encoded) confidence labels, with the added ability to relax the loss penalty for uncertain confidence labels.

In non-limiting embodiments, existing loss functions may be repurposed and modified to work with the probabilistic confidence labels described herein. For example, a cross-entropy loss (CE) function can be modified to work with probabilistic confidence labels by using the relaxed confidence label Tᵣ, rather than one-hot labels. Substitution of Tᵣ for one-hot labels can allow other loss functions such as L1, MSE, Focal Loss, and/or the like to also use confidence labels. For example, a projection cross-entropy (pCE) loss may be represented as:

L_{pCE}=−ΣTᵣ log(P(ϕ))

As an example, a small trusted set M may be used, which is a subset of the training dataset N. In scientific literature, a smaller set of higher-quality trusted labels such as M is sometimes called a probe set. By using trusted, high quality labels in M, higher confidence values can be assigned to the trusted set in relation to the larger set N. For example, in an example in which confidence score Cₐ(A) represents the confidence of class “A” of a number of different classes (e.g., A, B, and/or the like), within set M the confidence score Cₐ(A) may be set to 95 for the correct class A, and Cₐ(B)=0.05 for the similar class B, whereas in the rest of set N the confidence score Cₐ(A)=0.6 for the correct class A and Cₐ(B)=0.4 for the similar class B. In non-limiting embodiments, the training is based on the larger N training mix that includes the more confident M subset, but the M subset is not used to loss reweight or label correct. In some non-limiting embodiments, confidence labels may be generated based on the outputs of the existing trained neural network architectures by making use of the trained model's prediction. A weighted average of multiple trained models can be taken to generate confidence labels where the weights are based on the models' performance accuracy. This method can be used, for example, if there is a large number of target classes (e.g., 1000 label classes or the like), where manual confidence labeling would be inefficient.

In non-limiting embodiments, there may be a larger set of possible classes and a smaller set of classes for which probabilities are computed or assigned by human labelers. For example, human labelers may assign probability labels for a dog versus a wolf, but a dog-breed label might also be assigned without any associated probability. Such a secondary (non-probability) label might be assigned by the same human labeler, a different human labeler, or an AI model. In such circumstances, a non-limiting embodiment might use methods and/or systems herein to assist in training a first AI model to differentiate between dogs and wolfs and then use other methods to additionally train a second AI model to predict the dog breed. The two AI models may be independent or they may share data, connections, weights, and/or the like. In another non-limiting embodiment, an AI model that predicts the dog breed might be used as an additional source of information for another (e.g., different) AI model to ascertain how likely an overall dog label might be. In situations where not every class has a probability assigned, the gold-standard vector may have dimensionality matching the number of classes for which probabilities are available. It is appreciated that other hybrid systems may be possible, and as such there is no specific constraint that the number of classes match the dimensionality of the probability labels or the dimensionality of the gold-standard vector of probability-per-class values. Any configuration of probability labels and/or gold-standard vectors is possible.

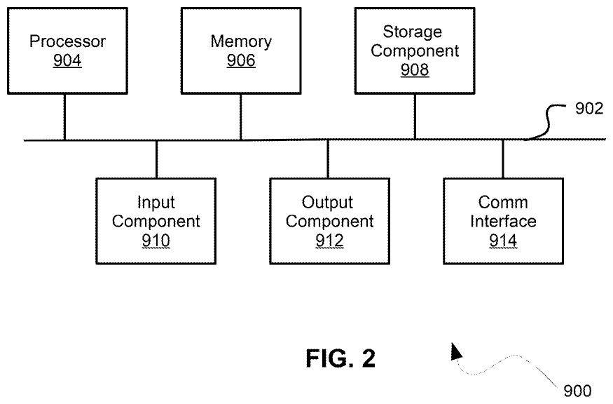

Referring now to FIG. 2, shown is a diagram of example components of a computing device 900 for implementing and performing the systems and methods described herein according to non-limiting embodiments. In some non-limiting embodiments, device 900 may include additional components, fewer components, different components, or differently arranged components than those shown. Device 900 may include a bus 902, a processor 904, memory 906, a storage component 908, an input component 910, an output component 912, and a communication interface 914. Bus 902 may include a component that permits communication among the components of device 900. In some non-limiting embodiments, processor 904 may be implemented in hardware, firmware, or a combination of hardware and software. For example, processor 904 may include a processor (e.g., a central processing unit (CPU), a graphics processing unit (GPU), an accelerated processing unit (APU), etc.), a microprocessor, a digital signal processor (DSP), and/or any processing component (e.g., a field-programmable gate array (FPGA), an application-specific integrated circuit (ASIC), etc.) that can be programmed to perform a function. Memory 906 may include random access memory (RAM), read only memory (ROM), and/or another type of dynamic or static storage device (e.g., flash memory, magnetic memory, optical memory, etc.) that stores information and/or instructions for use by processor 904.

With continued reference to FIG. 2, storage component 908 may store information and/or software related to the operation and use of device 900. For example, storage component 908 may include a hard disk (e.g., a magnetic disk, an optical disk, a magneto-optic disk, a solid state disk, etc.) and/or another type of computer-readable medium. Input component 910 may include a component that permits device 900 to receive information, such as via user input (e.g., a touch screen display, a keyboard, a keypad, a mouse, a button, a switch, a microphone, etc.). Additionally, or alternatively, input component 910 may include a sensor for sensing information (e.g., a global positioning system (GPS) component, an accelerometer, a gyroscope, an actuator, etc.). Output component 912 may include a component that provides output information from device 900 (e.g., a display, a speaker, one or more light-emitting diodes (LEDs), etc.). Communication interface 914 may include a transceiver-like component (e.g., a transceiver, a separate receiver and transmitter, etc.) that enables device 900 to communicate with other devices, such as via a wired connection, a wireless connection, or a combination of wired and wireless connections. Communication interface 914 may permit device 900 to receive information from another device and/or provide information to another device. For example, communication interface 914 may include an Ethernet interface, an optical interface, a coaxial interface, an infrared interface, a radio frequency (RF) interface, a universal serial bus (USB) interface, a Wi-Fi® interface, a cellular network interface, and/or the like.

Device 900 may perform one or more processes described herein. Device 900 may perform these processes based on processor 904 executing software instructions stored by a computer-readable medium, such as memory 906 and/or storage component 908. A computer-readable medium may include any non-transitory memory device. A memory device includes memory space located inside of a single physical storage device or memory space spread across multiple physical storage devices. Software instructions may be read into memory 906 and/or storage component 908 from another computer-readable medium or from another device via communication interface 914. When executed, software instructions stored in memory 906 and/or storage component 908 may cause processor 904 to perform one or more processes described herein. Additionally, or alternatively, hardwired circuitry may be used in place of or in combination with software instructions to perform one or more processes described herein. Thus, embodiments described herein are not limited to any specific combination of hardware circuitry and software. The term “programmed or configured,” as used herein, refers to an arrangement of software, hardware circuitry, or any combination thereof on one or more devices.

Although embodiments have been described in detail for the purpose of illustration, it is to be understood that such detail is solely for that purpose and that the disclosure is not limited to the disclosed embodiments, but, on the contrary, is intended to cover modifications and equivalent arrangements that are within the spirit and scope of the appended claims. For example, it is to be understood that the present disclosure contemplates that, to the extent possible, one or more features of any embodiment can be combined with one or more features of any other embodiment.

1. A method for training a machine-learning model, comprising:
labeling each object of a plurality of objects with a probabilistic confidence label comprising a probability classification score for each class of at least two classes, resulting in a plurality of probabilistic confidence labels associated with the plurality of objects; and
training, with at least one computing device, the machine-learning model based on the plurality of objects and the plurality of probabilistic confidence labels.

2. The method of claim 1, wherein labeling each object of the plurality of objects comprises:
receiving, from a plurality of labelers, a plurality of classification scores for each object of the plurality of objects; and
determining a weighted probability classification score for each object of the plurality of objects based on the plurality of classification scores for the object.

3. The method of claim 2, wherein the weighted probability classification score is based on weighing scores from each labeler of the plurality of labelers based on a corresponding confidence score of the labeler.

4. The method of claim 1, wherein labeling each object of the plurality of objects comprises:
receiving, from a plurality of machine-learning models, outputs comprising a plurality of probability classification scores for each object of the plurality of objects; and
combining the outputs.

5. The method of claim 4, wherein the plurality of machine-learning models comprises a plurality of artificial neural networks (ANNs), and wherein the outputs comprise outputs from each last layer of each ANN of the plurality of ANNs.

6. The method of claim 5, further comprising applying a softmax activation layer to each output before or after combining the outputs.

7. The method of claim 4, further comprising:
determining a weighted probability classification score for each object of the plurality of objects based on the plurality of probability classification scores for the object, wherein the weighted probability classification score is based on weighing scores from each machine-learning model of the plurality of machine-learning models based on a corresponding accuracy of the machine-learning model.

8. The method of claim 1, wherein labeling each object of the plurality of objects comprises:
receiving, from a plurality of labelers, a first plurality of probability classification scores for each object of the plurality of objects; and
receiving, from a plurality of ANNs, outputs from each last layer of each ANN of the plurality of ANNs, the outputs comprising a second plurality of probability classification scores for each object of the plurality of objects.

9. The method of claim 1, wherein training the machine-learning model comprises:
inputting at least one object of the plurality of objects to the machine-learning model;
receiving, from the machine-learning model, an output vector;
determining an inner product of the output vector and a vector based on the plurality of probabilistic confidence labels; and
optimizing the machine-learning model based on a loss function calculated based on the inner product.

10-21. (canceled)

22. A system for training a machine-learning model, comprising at least one computing device programmed or configured to:
label each object of a plurality of objects with a probabilistic confidence label comprising a probability classification score for each class of at least two classes, resulting in a plurality of probabilistic confidence labels associated with the plurality of objects; and
train the machine-learning model based on the plurality of objects and the plurality of probabilistic confidence labels.

23. The system of claim 22, wherein labeling each object of the plurality of objects comprises:
receiving, from a plurality of labelers, a plurality of classification scores for each object of the plurality of objects; and
determining a weighted probability classification score for each object of the plurality of objects based on the plurality of classification scores for the object.

24. The system of claim 23, wherein the weighted probability classification score is based on weighing scores from each labeler of the plurality of labelers based on a corresponding confidence score of the labeler.

25. The system of claim 22, wherein labeling each object of the plurality of objects comprises:
receiving, from a plurality of machine-learning models, outputs comprising a plurality of probability classification scores for each object of the plurality of objects; and
combining the outputs.

26. The system of claim 22, wherein the plurality of machine-learning models comprises a plurality of artificial neural networks (ANNs), and wherein the outputs comprise outputs from each last layer of each ANN of the plurality of ANNs.

27. The system of claim 22, wherein the computing device is further programmed or configured to apply a softmax activation layer to each output before or after combining the outputs.

28. The system of claim 22, wherein the computing device is further programmed or configured to:
determine a weighted probability classification score for each object of the plurality of objects based on the plurality of probability classification scores for the object, wherein the weighted probability classification score is based on weighing scores from each machine-learning model of the plurality of machine-learning models based on a corresponding accuracy of the machine-learning model.

29. The system of claim 22, wherein labeling each object of the plurality of objects comprises:
receiving, from a plurality of labelers, a first plurality of probability classification scores for each object of the plurality of objects; and
receiving, from a plurality of ANNs, outputs from each last layer of each ANN of the plurality of ANNs, the outputs comprising a second plurality of probability classification scores for each object of the plurality of objects.

30. The system of claim 22, wherein training the machine-learning model comprises:
inputting at least one object of the plurality of objects to the machine-learning model;
receiving, from the machine-learning model, an output vector;
determining an inner product of the output vector and a vector based on the plurality of probabilistic confidence labels; and
optimizing the machine-learning model based on a loss function calculated based on the inner product.

31-42. (canceled)

43. A computer program product for training a machine-learning model, comprising at least one non-transitory computer-readable medium including program instructions that, when executed by at least one computing device, cause the at least one computing device to:
label each object of a plurality of objects with a probabilistic confidence label comprising a probability classification score for each class of at least two classes, resulting in a plurality of probabilistic confidence labels associated with the plurality of objects; and
train the machine-learning model based on the plurality of objects and the plurality of probabilistic confidence labels.

44. The computer program product of claim 43, wherein labeling each object of the plurality of objects comprises:
receiving, from a plurality of labelers, a plurality of classification scores for each object of the plurality of objects; and
determining a weighted probability classification score for each object of the plurality of objects based on the plurality of classification scores for the object.

45-63. (canceled)
